(19) United States
(12) Patent Application Publication
(10) Pub. No.: US 2025/0118780 A1
(43) Pub. Date: Apr. 10, 2025

(54) FLUID CONTAINER AND ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/637,847

(22) Filed: Apr. 17, 2024

Related U.S. Application Data
(63) Continuation of application No. PCT/JP2023/036375, filed on Oct. 5, 2023.

(51) Int. Cl. H01M 8/04082; H01M 8/0258

(52) U.S. Cl. CPC H01M 8/04216; H01M 8/0258

(57) ABSTRACT

A fluid container includes a first metallic member, a second metallic member, an adherence part, a first interface, and a second interface. The first metallic member contains chromium. The second metallic member contains chromium. The adherence part is made of an oxide containing chromium as a primary component. The adherence part adheres the first and second metallic members to each other. The first interface is provided as an interface between the first metallic member and the adherence part. The second interface is provided as an interface between the second metallic member and the adherence part. The first interface includes a first slant portion. The first slant portion slants with respect to an in-plane direction of the first metallic member.

### CROSS-REFERENCE TO RELATED APPLICATION

This is a continuation of PCT/JP2023/036375, filed Oct. 5, 2023, the entire contents of which are hereby incorporated by reference.

### TECHNICAL FIELD

The present invention relates to a fluid container and an electrochemical cell.

### BACKGROUND ART

Electrochemical cells such as electrolytic cells and fuel cells include a fluid container to supply a fluid to a cell body thereof. For example, a fluid container disclosed in JP2015-156352A includes a first inter-connector, a second inter-connector, a separator, a fuel electrode frame, and a glass seal.

The first inter-connector is connected to an air electrode of a fuel cell. The second inter-connector is connected to a fuel electrode-side electricity collecting layer of the fuel cell. The separator is connected to a solid electrolyte of the fuel cell and divides a channel for fuel gas and that for oxidant gas from each other. The fuel electrode frame is disposed between the separator and the second inter-connector. The glass seal adheres the first inter-connector and the separator to each other.

### SUMMARY OF THE INVENTION

### Technical Problems

In such a fluid container as described above, a first metallic member and a second metallic member are adhered to each other by an adherence part. In the fluid container, a difference in thermal expansion is caused between the first and second metallic members due to such a reason as a thermal cycle caused with activation and deactivation of the electrochemical cell, whereby a shear stress acts on an interface between the first metallic member and the adherence part. As a result, it is concerned that peeling occurs on the interface between the first metallic member and the adherence part.

It is an object of the present invention to provide a fluid container and an electrochemical cell, whereby peeling can be inhibited from occurring on an interface between a first metallic member and an adherence part.

### Solution to Problems

A fluid container according to a first aspect is a fluid container including an internal space through which a fluid flows. The fluid container includes a first metallic member, a second metallic member, an adherence part, a first interface, and a second interface. The first metallic member contains chromium. The second metallic member contains chromium. The adherence part is made of an oxide containing chromium as a primary component. The adherence part adheres the first and second metallic members to each other. The first interface is provided as an interface between the first metallic member and the adherence part. The second interface is provided as an interface between the second metallic member and the adherence part. The first interface includes a first slant portion. The first slant portion slats with respect to an in-plane direction of the first metallic member.

According to the configuration, the first interface, provided as the interface between the first metallic member and the adherence part, includes the first slant portion slanting with respect to the in-plane direction of the first metallic member. Because of this, a shear stress, acting on the first interface in the in-plane direction, can be changed, in part, to act thereon in the thickness direction. As a result, peeling can be inhibited from occurring on the interface between the first metallic member and the adherence part.

A fluid container according to a second aspect relates to the fluid container according to the first aspect and is configured as follows. The adherence part annularly extends to enclose the internal space. The first slant portion extends along the adherence part.

A fluid container according to a third aspect relates to the fluid container according to the first or second aspect and is configured as follows. The first slant portion slants in a direction oriented from the internal space toward an outer peripheral edge of the fluid container.

A fluid container according to a fourth aspect relates to the fluid container according to any of the first to third aspects and is configured as follows. The second interface includes a second slant portion slanting with respect to an in-plane direction of the second metallic member.

A fluid container according to a fifth aspect relates to the fluid container according to the fourth aspect and is configured as follows. The first and second slant portions overlap with each other as seen in a thickness direction and slant to approach to each other in a direction oriented from the internal space toward an outer peripheral edge of the fluid container.

A fluid container according to a sixth aspect relates to the fluid container according to the fifth aspect and is configured as follows. The first interface includes a third slant portion slanting with respect to the in-plane direction of the first metallic member. The second interface includes a fourth slant portion slanting with respect to the in-plane direction of the second metallic member. The third slant portion is disposed closer to the outer peripheral edge than the first slant portion. The fourth slant portion is disposed closer to the outer peripheral edge than the second slant portion. The third and fourth slant portions overlap with each other as seen in the thickness direction and slant to separate from each other in the direction oriented from the internal space toward the outer peripheral edge.

A fluid container according to a seventh aspect relates to the fluid container according to the sixth aspect and is configured as follows. The adherence part includes a first taper portion and a second taper portion. The first taper portion is defined by the first and second slant portions. The second taper portion is defined by the third and fourth slant portions. The first taper portion is greater in taper ratio than the second taper portion.

A fluid container according to an eighth aspect relates to the fluid container according to the sixth aspect and further includes a metallic joint portion. The metallic joint portion is integrated with the first and second metallic members. The metallic joint portion is made of a metallic material. The adherence part includes a first taper portion and a second taper portion. The first taper portion is defined by the first and second slant portions. The second taper portion is defined by the third and fourth slant portions. The metallic joint portion is disposed between the first taper portion and the second taper portion.

A fluid container according to a ninth aspect relates to the fluid container according to any of the first to eighth aspects and is configured as follows. The adherence part includes an unfilled portion, extending in the in-plane direction of the first metallic member, in an interior thereof.

A fluid container according to a tenth aspect relates to the fluid container according to any of the first to ninth aspects and is configured as follows. The adherence part includes a plurality of layers. The number of layers in the adherence part varies in a direction oriented from the internal space toward an outer peripheral edge of the fluid container.

A fluid container according to an eleventh aspect relates to the fluid container according to any of the first to tenth aspects and is configured as follows. The number of layers in the adherence part decreases in the direction oriented from the internal space toward the outer peripheral edge of the fluid container.

A fluid container according to a twelfth aspect relates to the fluid container according to any of the first to eleventh aspects and is configured as follows. The adherence part is a seal for sealing the internal space.

An electrochemical cell according to a thirteenth aspect includes the fluid container recited in any of the first to twelfth aspect and a cell body disposed on the fluid container.

An electrochemical cell according to a fourteenth aspect relates to the electrochemical cell according to the thirteenth aspect and is configured as follows. The first metallic member includes a plurality of communicating holes continuing to the internal space. The cell body is disposed on the first metallic member to cover the plurality of communicating holes.

An electrochemical cell according to a fifteenth aspect relates to the electrochemical cell according to the thirteenth aspect and is configured as follows. The second metallic member includes a plurality of communicating holes continuing to the internal space. The cell body is disposed on the second metallic member to cover the plurality of communicating holes.

### Advantageous Effects of Invention

According to the present invention, peeling can be inhibited from occurring on an interface between a first metallic member and an adherence part.

### BRIEF DESCRIPTION OF THE DRAWINGS

FIG. 1 is a plan view of an electrolytic cell.

FIG. 2 is a cross-sectional view of FIG. 1 taken along line II-II.

FIG. 3 is an enlarged cross-sectional view of a first adherence part and the surroundings thereof.

FIG. 4 is an enlarged cross-sectional view of the first adherence part and the surroundings thereof in a modification.

FIG. 5 is an enlarged cross-sectional view of the first adherence part and the surroundings thereof in another modification.

FIG. 6 is an enlarged cross-sectional view of the first adherence part and the surroundings thereof in yet another modification.

### DESCRIPTION OF EMBODIMENTS

### <Electrolytic Cell>

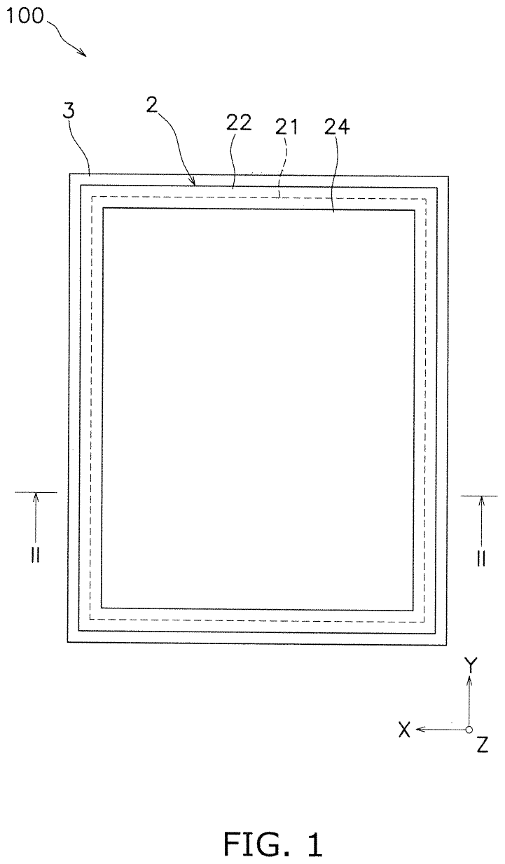

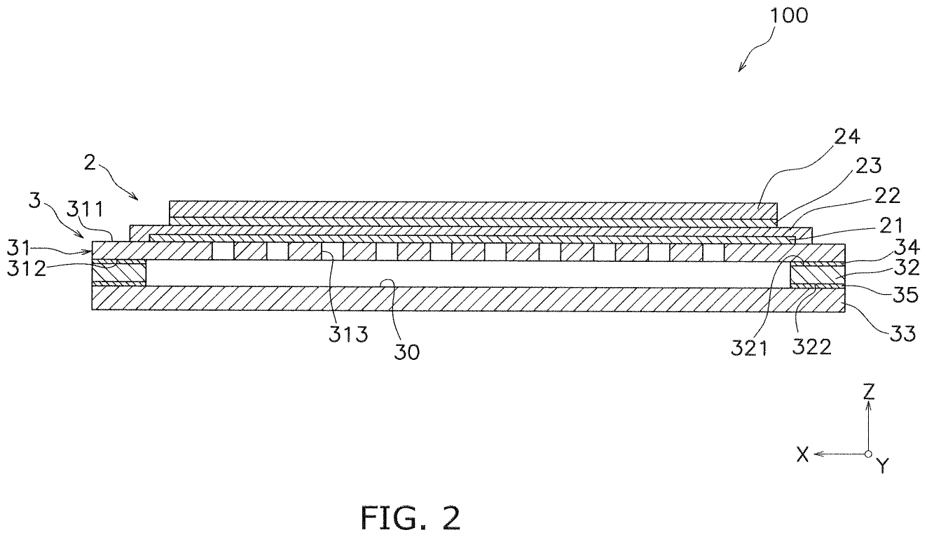

FIG. 1 is a plan view of an electrolytic cell 100. FIG. 2 is a cross-sectional view of FIG. 1 taken along line II-II.

As shown in FIG. 1, the electrolytic cell 100 (exemplary electrochemical cell) is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the planar shape of the electrolytic cell 100 is not particularly limited to a specific shape, and hence, may be any shape other than the rectangle, such as a polygon, an ellipse, or a circle.

As shown in FIGS. 1 and 2, the electrolytic cell 100 includes a cell body 2 and a fluid container 3.

### <Cell Body>

The cell body 2 is disposed on the fluid container 3. The cell body 2 is supported by a metallic support 31 (to be described) composing part of the fluid container 3. The cell body 2 is disposed on the metallic support 31 to cover a plurality of communicating holes 313 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the fluid container 3 side along the Z-axis direction. The hydrogen electrode 21, the electrolyte 22, and the oxygen electrode 24 are essential components; however, the reaction preventing layer 23 is a component provided on an arbitrary basis.

### <Hydrogen Electrode>

The hydrogen electrode 21 is disposed on a first principal surface 311 of the metallic support 31. The hydrogen electrode 21 is supplied with raw material gas from each of the communicating holes 313 of the metallic support 31. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

Hydrogen electrode 21: H₂O+2e⁻→H₂+O²⁻ (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

Hydrogen electrode 21: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

H₂ generated in the hydrogen electrode 21 flows out through each of the communicating holes 313 of the metallic support 31 to an internal space 30 (to be described).

The hydrogen electrode 21 is a porous body with electronic conductivity. The hydrogen electrode 21 contains nickel (Ni). In co-electrolysis, Ni functions not only functions as an electron transmitter but also functions as a thermal catalyst that maintains a gas composition appropriate for methanation, FR (Fischer-Tropsch) synthesis, and so forth by promoting thermal reactions between H₂ to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr) (Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 20×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### <Electrolyte>

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 311 of the metallic support 31.

The electrolyte 22 is a dense body with oxide ionic conductivity. The electrolyte 22 transmits O²⁻, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/° C.

The electrolyte 22 is not particularly limited in method of formation, and hence, can be formed by any of the methods such as firing, spray coating, PVD, and CVD.

### <Reaction Preventing Layer>

The reaction preventing layer 23 is disposed between the electrolyte 22 and the oxygen electrode 24. The reaction preventing layer 23 is disposed on the opposite side of the side on which the hydrogen electrode 21 is disposed with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### <Oxygen Electrode>

The oxygen electrode 24 is disposed on the opposite side of the side on which the hydrogen electrode 21 is disposed with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 through the electrolyte 22 by chemical reactions expressed by the following formula (5).

Oxygen electrode 24: 2O²⁻→O₂+4e⁻ (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr) (Co, Fe)O₃, (La, Sr)FeO₃, La(Ni, Fe)O₃, (La, Sr)CoO₃, and (Sm, Sr)CoO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### <Fluid Container>

As shown in FIG. 2, the fluid container 3 includes the internal space 30. The raw material gas to be supplied to the hydrogen electrode 21 and reducing gas (H₂ in the present preferred embodiment) to be generated in the hydrogen electrode 21 flow into the internal space 30. It should be noted that the raw material gas and the reducing gas are exemplary fluids of the present invention.

The fluid container 3 includes the metallic support 31 (exemplary first metallic member), a frame 32 (exemplary second metallic member), an inter-connector 33, a first adherence part 34 (exemplary adherence part), and a second adherence part 35. The internal space 30 is a space enclosed by the metallic support 31, the frame 32, the inter-connector 33, the first adherence part 34, and the second adherence part 35.

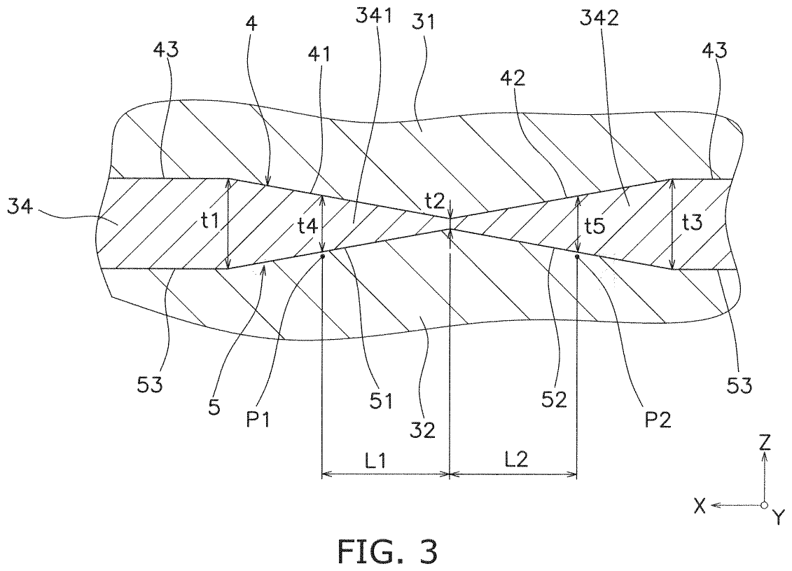

Besides, as shown in FIG. 3, the fluid container 3 includes a first interface 4 and a second interface 5. FIG. 3 is an enlarged cross-sectional view, shown in detail, of the first adherence part 34 and the surroundings thereof.

### <Metallic Support>

As shown in FIG. 2, the metallic support 31 supports the cell body 2. In the present preferred embodiment, the metallic support 31 is made in shape of a plate. Insomuch as the cell body 2 can be supported by the metallic support 31, the metallic support 31 is not particularly limited in thickness, and hence, can be set to have a thickness of, for instance, greater than or equal to 0.1 mm and less than or equal to 2.0 mm.

The metallic support 31 includes the plural communicating holes 313, the first principal surface 311, and a second principal surface 312.

Each communicating hole 313 penetrates the metallic support 31 from the first principal surface 311 to the second principal surface 312. Each communicating hole 313 is opened on each of the first and second principal surfaces 311 and 312. Each communicating hole 313 is covered with the cell body 2. Specifically, the first principal surface 311-side opening of each communicating hole 313 is covered with the hydrogen electrode 21. The second principal surface 312-side opening of each communicating hole 313 continues to the internal space 30.

Each communicating hole 313 can be formed by machining processing (e.g., punching), laser processing, chemical processing (e.g., etching), or so forth.

In the present preferred embodiment, each communicating hole 313 is shaped straight along the Z-axis direction. However, each communicating hole 313 may slant with respect to the Z-axis direction; besides or alternatively, each communication hole 313 may not be shaped straight. Besides or alternatively, the communicating holes 313 may continue to each other.

The first principal surface 311 is provided on the opposite side of the second principal surface 312. The cell body 2 is disposed on the first principal surface 311. The frame 32 is joined to the second principal surface 312 through the first adherence part 34.

The metallic support 31 is made of an alloy containing Cr (Chromium). Fe—Cr-based alloy steel (stainless steel, etc.), Ni—Cr-based alloy steel, or so forth can be exemplified as the alloy herein described. The metallic support 31 is not particularly limited in content rate of Cr, and hence, can be set to contain Cr at a content rate of greater than or equal to 4 mass % and less than or equal to 30 mass %.

The metallic support 31 may contain Ti (Titanium) and Zr (Zirconium). The metallic support 31 is not particularly limited in content rate of Ti, and hence, can be set to contain Ti at a content rate of greater than or equal to 0.01 mol % and less than or equal to 1.0 mol %. The metallic support 31 is not particularly limited in content rate of Zr, and hence, can be set to contain Zr at a content rate of greater than or equal to 0.01 mol % and less than or equal to 0.4 mol %. The metallic support 31 may contain Ti in the form of TiO₂ (titania) and may contain Zr in the form of ZrO₂ (zirconia).

### <Frame>

The frame 32 is a spacer for forming the internal space 30. The frame 12 is annularly shaped in the present preferred embodiment. The frame 32 is joined to the metallic support 31 through the first adherence part 34, while being joined to the inter-connector 33 through the second adherence part 35. The frame 32 is not particularly limited in thickness, and hence, can be set to have a thickness of, for instance, greater than or equal to 0.1 mm and less than or equal to 2.0 mm.

The frame 32 includes a first principal surface 321 and a second principal surface 322. The first principal surface 321 of the frame 32 is a surface facing the metallic support 31. The second principal surface 322 of the frame 32 is a surface facing the inter-connector 33.

The frame 32 is made of an alloy containing Cr. Fe—Cr-based alloy steel, Ni—Cr-based alloy steel, or so forth can be exemplified as the alloy herein described. The frame 32 is not particularly limited in content rate of Cr, and hence, can be set to contain Cr at a content rate of greater than or equal to 4 mass % and less than or equal to 30 mass %. The frame 32 may be identical in composition to or different in composition from the metallic support 31.

### <Inter-Connector>

The inter-connector 33 is disposed on the opposite side of the side on which the metallic support 31 is disposed with reference to the frame 32. The inter-connector 33 is a member for electrically connecting the electrolytic cell 100 to either an external power source or another electrolytic cell.

The inter-connector 33 is made in shape of a plate. The inter-connector 33 is joined to the frame 32 through the second adherence part 35. The inter-connector 33 is not particularly limited in thickness, and hence, can be set to have a thickness of, for instance, greater than or equal to 0.1 mm and less than or equal to 2.0 mm.

The inter-connector 33 is made of an alloy containing Cr. Fe—Cr-based alloy steel, Ni—Cr-based alloy steel, or so forth can be exemplified as the alloy herein described. The inter-connector 33 is not particularly limited in content rate of Cr, and hence, can be set to contain Cr at a content rate of greater than or equal to 4 mass % and less than or equal to 30 mass %. The inter-connector 33 may be identical in composition to or different in composition from the metallic support 31. The inter-connector 33 may be identical in composition to or different in composition from the frame 32.

### <First Adherence Part>

The first adherence part 34 is disposed between the metallic support 31 and the frame 32. The first adherence part 34 adheres the metallic support 31 and the frame 32 to each other. When described in detail, the first adherence part 34 is joined to each of the metallic support 31 and the frame 32.

The first adherence part 34 seals a gap between the metallic support 31 and the frame 32. Accordingly, the raw material gas to be supplied to the hydrogen electrode 21 and the reducing gas to be generated in the hydrogen electrode 21 can be prevented from leaking out through the gap between the metallic support 31 and the frame 32.

The first adherence part 34 is disposed between the metallic support 31 and the frame 32. The first adherence part 34 is interposed between the metallic support 31 and the frame 32. The first adherence part 34 annularly extends to enclose the internal space 30. The first adherence part 34 functions as a seal for sealing the internal space 30. In other words, the first adherence part 34 annularly extends in a continuous manner.

The first adherence part 34 is made of an oxide containing Cr as a primary component (hereinafter abbreviated as “Cr oxide”). Accordingly, during manufacturing or operating the electrolytic cell 100, Cr can be inhibited from diffusing from the metallic support 31 and the frame 32 to the first adherence part 34. Besides, even if Cr diffuses from the metallic support 31 and the frame 32 to the first adherence part 34, the diffused Cr is not so much as affecting the composition of the first adherence part 34; hence, deterioration in strength of the first adherence part 34 can be inhibited as well. Furthermore, the metallic support 31, the frame 32, and the first adherence part 34 contain Cr in common, whereby adherence property can be enhanced among the metallic support 31, the frame 32, and the first adherence part 34. Therefore, adherence property of the metallic support 31 and the frame 32 can be maintained over a long period of time.

It should be noted that in the present preferred embodiment, “the Cr oxide, of which the first adherence part 34 is made, contains Cr as the primary component” means that Cr is the highest in content rate among metallic elements of the Cr oxide when the composition of the Cr oxide is analyzed by an energy dispersive spectrometer (EDS). The Cr oxide is not particularly limited in content rate of Cr among the metallic elements, and hence, can be set to contain Cr at a content rate of, for instance, greater than or equal to 20 mol % and less than or equal to 100 mol %.

The Cr oxide, of which the first adherence part 34 is made, preferably contains Cr among the metallic elements thereof at a content rate of greater than or equal to 50 mol %. Accordingly, Cr contained in the metallic support 31 and the frame 32 can be remarkably inhibited from being diffused to the first adherence part 34.

The Cr oxide, of which the first adherence part 34 is made, is preferably composed of at least either chromium oxide or chromium manganese oxide. The oxides herein described have properties that Cr is especially unlikely to diffuse; hence, the first adherence part 34 can be thereby enhanced in durability.

Cr₂O₃ or so forth can be exemplified as the chromium oxide. MnCr₂O₄ (spinel), Mn_{1.5}Cr_{1.5}O₄ (spinel), or so forth can be exemplified as the chromium manganese oxide.

The Cr oxide, of which the first adherence part 34 is made, is preferably crystalline. Because of this, even if the electrolytic cell 100 is operated for a long period of time, it is made possible to avoid occurrence of such a situation that the Cr oxide transitions from a non-crystalline phase to a crystalline phase, whereby the first adherence part 34 is undesirably damaged or broken.

The Cr oxide, of which the first adherence part 34 is made, preferably has either a spinel crystal structure or a corundum crystal structure. The crystal structures herein described are high in symmetry; hence, the first adherence part 34 can be thereby enhanced in endurance against thermal stress.

The first adherence part 34 can be formed by applying a paste containing the Cr oxide onto at least either the surface of the metallic support 31 or that of the frame 32, and then, by conducting a thermal treatment in a state that the metallic support 31 and the frame 32 are closely contacted to each other. Conditions for the thermal treatment can be arbitrarily set but the following can be set as exemplary conditions for the thermal treatment: a temperature of greater than or equal to 600° C. and less than or equal to 1100° C. and a duration of greater than or equal to 0.5 hours and less than or equal to 24 hours.

### <Second Adherence Part>

The second adherence part 35 is disposed between the frame 32 and the inter-connector 33. The second adherence part 35 adheres the frame 32 and the inter-connector 33 to each other. When described in detail, the second adherence part 35 is joined to each of the frame 32 and the inter-connector 33.

The second adherence part 35 seals a gap between the frame 32 and the inter-connector 33. Accordingly, the raw material gas to be supplied to the hydrogen electrode 21 and the reducing gas to be generated in the hydrogen electrode 21 are prevented from being leaked out through the gap between the frame 32 and the inter-connector 33.

The second adherence part 35 is substantially identical in configuration to the first adherence part 34 described above; hence, in the present preferred embodiment, explanation will be omitted for the configuration of the second adherence part 35.

### <First and Second Interfaces>

As shown in FIG. 3, the first interface 4 is an interface between the metallic support 31 and the first adherence part 34. The first interface 4 includes a first slant portion 41 and a third slant portion 42. The first and third slant portions 41 and 42 slant with respect to in-plane directions of the metallic support 31. Besides, the first interface 4 includes a first planar portion 43. The first planar portion 43 extends substantially in parallel to the in-plane directions of the metallic support 31. It should be noted that “the in-plane directions of the metallic support 31” refer to extending directions of a region, other than a region composing part of the first slant portion 41 and that composing part of the third slant portion 42, on the second principal surface 312 of the metallic support 31; hence, the in-plane directions of the metallic support 31 correspond to XY plane directions thereof.

The first and third slant portions 41 and 42 annularly extend along the first adherence part 34. The first and third slant portions 41 and 42 may annularly extend in either a continuous manner or an intermittent manner. The third slant portion 42 is disposed on the outer peripheral edge side (the right side in FIG. 3) of the first slant portion 41 in the fluid container 3. The first and third slant portions 41 and 42 continue to each other.

The first and third slant portions 41 and 42 slant in a direction oriented from the internal space 30 toward the outer peripheral edge of the fluid container 3. In other words, the first and third slant portions 41 and 42 slant to face toward a thickness direction (the Z-axis direction), while extending in the direction oriented from the internal space 30 toward the outer peripheral edge of the fluid container 3.

Specifically, the first slant portion 41 slants to approach the frame 32 in the direction oriented from the internal space 30 toward the outer peripheral edge of the fluid container 3 (rightward in FIG. 3). On the other hand, the third slant portion 42 slants to separate from the frame 32 in the direction oriented from the internal space 30 toward the outer edge of the fluid container 3. The first and third slant portions 41 and 42 slant to the opposite sides from each other in the direction oriented from the internal space 30 toward the outer peripheral edge of the fluid container 3.

The first planar portion 43 is disposed closer to the internal space 30 than the first slant portion 41. The first planar portion 43 is greater in length than the first slant portion 41 in the direction oriented from the internal space 30 toward the outer peripheral edge of the fluid container 3. Besides, the first planar portion 43 may be disposed closer to the outer peripheral edge of the fluid container 3 than the third slant portion 42.

The second interface 5 is an interface between the frame 32 and the first adherence part 34. The second interface 5 includes a second slant portion 51 and a fourth slant portion 52. The second and fourth slant portions 51 and 52 slant with respect to in-plane directions of the frame 32. Besides, the second interface 5 includes a second planar portion 53. The second planar portion 53 extends substantially in parallel to the in-plane directions of the frame 32. It should be noted that “the in-plane directions of the frame 32” refer to extending directions of a region, other than a region composing part of the second slant portion 51 and that composing part of the fourth slant portion 52, on the first principal surface 321 of the frame 32; hence, the in-plane directions of the frame 32 correspond to XY plane directions thereof. The in-plane directions of the frame 32 are oriented substantially in parallel to those of the metallic support 31.

The second and fourth slant portions 51 and 52 annularly extend along the first adherence part 34. The second and fourth slant portions 51 and 52 may annularly extend in either a continuous manner or an intermittent manner. The fourth slant portion 52 is disposed on the outer peripheral edge side (the right side in FIG. 3) of the second slant portion 51 in the fluid container 3. The second and fourth slant portions 51 and 52 continue to each other.

The second and fourth slant portions 51 and 52 slant in the direction oriented from the internal space 30 toward the outer peripheral edge of the fluid container 3. In other words, the second and fourth slant portions 51 and 52 slant to face toward the thickness direction (the Z-axis direction), while extending in the direction oriented from the internal space 30 toward the outer peripheral edge of the fluid container 3.

Specifically, the second slant portion 51 slants to approach the metallic support 31 in the direction oriented from the internal space 30 toward the outer peripheral edge of the fluid container 3 (rightward in FIG. 3). On the other hand, the fourth slant portion 52 slants to separate from the metallic support 31 in the direction oriented from the internal space 30 toward the outer peripheral edge of the fluid container 3. The second and fourth slant portions 51 and 52 slant to the opposite sides from each other in the direction oriented from the internal space 30 toward the outer peripheral edge of the fluid container 3.

The second planar portion 53 is disposed closer to the internal space 30 than the first slant portion 41. The second planar portion 53 is greater in length than the first slant portion 41 in the direction oriented from the internal space 30 toward the outer peripheral edge of the fluid container 3. Besides, the second planar portion 53 may be disposed closer to the outer peripheral edge of the fluid container 3 than the fourth slant portion 52.

The first and second slant portions 41 and 51 overlap with each other as seen in the thickness direction (the Z-axis direction). The first and second slant portions 41 and 51 slant to approach to each other in the direction oriented from the internal space 30 toward the outer peripheral edge of the fluid container 3 (rightward in FIG. 3).

The first adherence part 34 includes a first taper portion 341 defined by the first and second slant portions 41 and 51. The first taper portion 341 gradually decreases in thickness (t) in the direction oriented from the internal space 30 toward the outer peripheral edge of the fluid container 3. The maximum thickness (t1) of the first taper portion 341 is, for instance, greater than or equal to 1 μm and less than or equal to 100 μm, whereas the minimum thickness (t2) thereof is, for instance, greater than or equal to 0.1 μm and less than or equal to 10 μm. Besides, the thickness of the first adherence part 34, except for that of the first taper portion 341 and that of a second taper portion 342 (to be described), is substantially identical to the maximum thickness t1 of the first taper portion 341. It should be noted that “the thickness of the first adherence part 34” refers to a dimension between the first and second planar portions 43 and 53. Here, “the thickness” refers to a dimension in an orthogonal direction (the Z-axis direction) to the in-plane directions (the XY plane directions) of the metallic support 31.

A taper ratio ((t4−t2)/L1) of the first taper portion 341 is, for instance, greater than or equal to 0.01 and less than or equal to 0.1. Here, “t4” means the thickness of the first taper portion 341 at a point P1 remote from a point, at which the first taper portion 341 has the minimum thickness (t2), toward the internal space 30 by a distance L1. It should be noted that values of the thickness of the first taper portion 341 are measured at three points within a range of +10 μm from the point P1 in the X-axis direction shown in FIG. 3; then, an average of the measured values is set as the thickness t4. Here, the point P1 is shifted in position by setting the distance L1 to be 100 μm, 200 μm, 300 μm, 400 μm, and 500 μm; thus, values of the thickness t4 are measured at the shifted positions of the point P1. Based on the above, values of the taper ratio are calculated. The first taper portion 341 is shaped such that any of the values of the taper ratio herein calculated can fall in a range of numeric values of the taper ratio described above.

The third and fourth slant portions 42 and 52 overlap with each other as seen in the thickness direction (the Z-axis direction). The third and fourth slant portions 42 and 52 slant to separate from each other from in the direction oriented from the internal space 30 toward the outer peripheral edge of the fluid container 3 (rightward in FIG. 3).

The first adherence part 34 includes the second taper portion 342 defined by the third and fourth slant portions 42 and 52. The second taper portion 342 gradually increases in thickness (t) in the direction oriented from the internal space 30 toward the outer peripheral edge of the fluid container 3. The maximum thickness (t3) of the second taper portion 342 is, for instance, greater than or equal to 1.0 μm and less than or equal to 100 μm. The second taper portion 342 continues at the thinnest portion thereof to the first taper portion 341; hence, the minimum thickness (t2) thereof is identical to that of the first taper portion 341.

A taper ratio ((t5−t2)/L2) of the second taper portion 342 is, for instance, greater than or equal to 0.01 and less than or equal to 0.1. Here, “t5” means the thickness of the second taper portion 342 at a point P2 remote from a point, at which the second taper portion 342 has the minimum thickness (t2), toward the internal space 30 by a distance L2. It should be noted that values of the thickness of the second taper portion 342 are measured at three points within a range of +10 μm from the point P2 in the X-axis direction in FIG. 3; then, an average of the measured values is set as the thickness t5. Here, the point P2 is shifted in position by setting the distance L2 to be 100 μm, 200 μm, 300 μm, 400 μm, and 500 μm; thus, values of the thickness t5 are measured at the shifted positions of the point P2. Based on the above, values of the taper ratio are calculated. The second taper portion 342 is shaped such that any of the values of the taper ratio herein calculated can fall in a range of numeric values of the taper ratio described above.

The first taper portion 341 can be set to be greater in taper ratio than the second taper portion 342. By thus setting the first taper portion 341 to be greater in taper ratio than the second taper portion 342, the first taper portion 341 can be relatively enhanced in mechanical reliability.

### <Manufacturing Method>

A method of manufacturing the first interface 4, the second interface 5, and the first adherence part 34 will be hereinafter explained. First, bending such as stamping is conducted for the metallic support 31, whereby a region adhered to the first adherence part 34 (i.e., a region composing part of the first interface 4) on the second principal surface 312 of the metallic support 31 is shaped as described above. It should be noted that the region can be also shaped as described above when the metallic support 31 is processed to be reduced in thickness by conducting cutting, etching, laser abrasion, or so forth for the second principal surface 312.

Likewise, bending such as stamping is conducted for the frame 32, whereby a region adhered to the first adherence part 34 (i.e., a region composing part of the second interface 5) on the first principal surface 321 of the frame 32 is shaped as described above.

Then, the first adherence part 34 can be formed by applying a paste containing crystalline metallic oxide to at least either the surface of the metallic support 31 or that of the frame 32, and then, by conducting a thermal treatment in a state that the metallic support 31 and the frame 32 are closely contacted to each other. Conditions for the thermal treatment can be arbitrarily set. For example, the following can be set as the conditions for the thermal treatment: a temperature of greater than or equal to 600° C. and less than or equal to 1100° C. and a duration of greater than or equal to 0.5 hours and less than or equal to 24 hours.

### Modifications of Preferred Embodiment

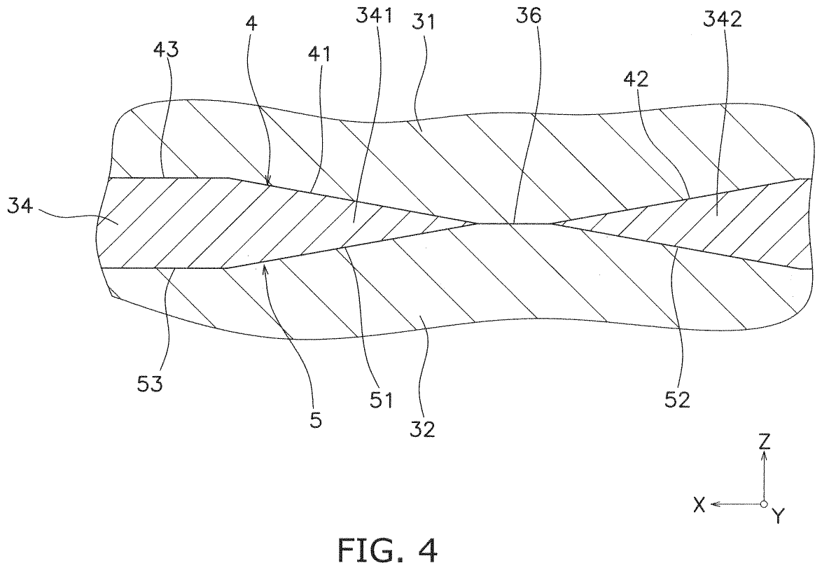

One preferred embodiment of the present invention has been explained above. However, the present invention is not limited to this, and a variety of changes can be made without departing from the gist of the present invention.
(a) In the preferred embodiment described above, the frame 32 and the inter-connector 33 are provided as separate members but may be provided as an integrated member. In this case, the fluid container 3 does not include the second adherence part 35.
(b) In the preferred embodiment described above, the metallic support 31 and the frame 32 are provided as separate members but may be provided as an integrated member. In this case, the fluid container 3 does not include the first adherence part 34.
(c) In the preferred embodiment described above, the metallic support 31 is exemplified as the first metallic member, whereas the frame 32 is exemplified as the second metallic member; however, the fluid container 3 is not limited in configuration to this. For example, the frame 32 may be exemplified as the first metallic member, whereas the metallic support 31 may be exemplified as the second metallic member.
(d) As shown in FIG. 4, the first and second taper portions 341 and 342 may be separated from each other. In this case, the fluid container 3 further includes a metallic joint portion 36. The metallic joint portion 36 is disposed between the first and second taper portions 341 and 342.

The metallic joint portion 36 is made of a metallic material. The metallic joint portion 36 may be identical in composition to either the metallic support 31 or the frame 32; alternatively, the metallic joint portion 36 may have a composition obtained by mixing the composition of the metallic support 31 and that of the frame 32. Yet alternatively, the metallic joint portion 36 may be different in composition from each of the metallic support 31 and the frame 32.

The metallic joint portion 36 is integrated with the metallic support 31 and the frame 32. For example, the metallic joint portion 36 can be formed by either welding or brazing the metallic support 31 and the frame 32. The metallic joint portion 36 according to the present preferred embodiment is formed by lap-welding the metallic support 31 and the frame 32.

The metallic joint portion 36 is disposed between the first and second taper portions 341 and 342; hence, the metallic joint portion 36 is isolated from the internal space 30. Because of this, the metallic joint portion 36 is not exposed to the internal space 30.

Accordingly, the reducing gas (H₂ in the present preferred embodiment), flowing through the internal space 30, can be inhibited from contacting with the metallic joint portion 36; hence, the metallic joint portion 36 can be inhibited from being deteriorated (e.g., embrittled) by the reducing gas. Besides, in the present preferred embodiment, the water vapor, flowing through the internal space 30, can be also inhibited from contacting with the metallic joint portion 36; hence, the metallic joint portion 36 can be also inhibited from being eroded by the water vapor.

Furthermore, the metallic joint portion 36 is disposed between the first and second taper portions 341 and 342; hence, the metallic joint portion 36 is isolated from the external space of the fluid container 3. Because of this, the metallic joint portion 36 is not exposed to the external space.

Accordingly, water vapor, contained in the air of the external space, can be inhibited from contacting with the metallic joint portion 36; hence, the metallic joint portion 36 can be further inhibited from being eroded by the water vapor.

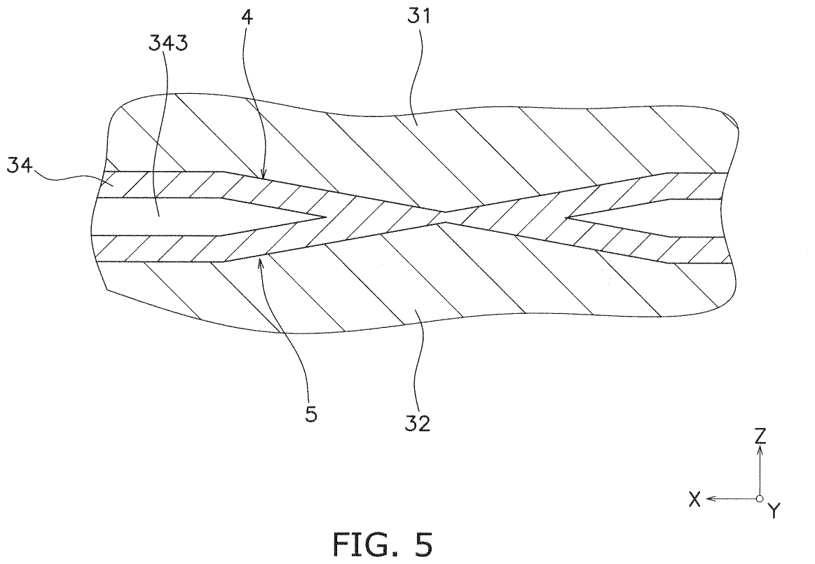

(e) As shown in FIG. 5, the first adherence part 34 may include, in the interior thereof, an unfilled portion 343 extending in the in-plane directions of the metallic support 31. With the unfilled portion 343 herein provided, a stress produced within the first adherence part 34 can be lessened.

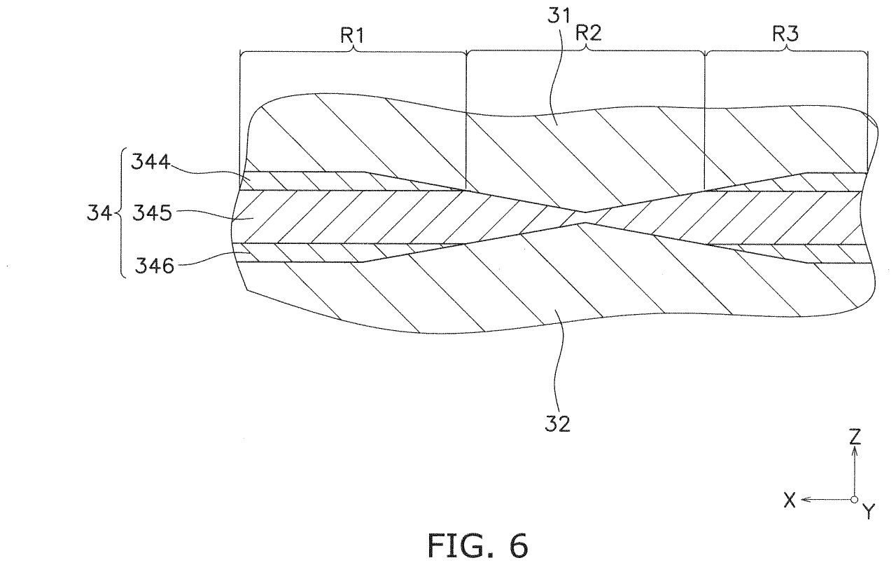

(f) As shown in FIG. 6, the first adherence part 34 may be composed of a plurality of layers. For example, the first adherence part 34 is composed of a first layer 344, a second layer 345, and a third layer 346.

The first layer 344 is disposed on the metallic support 31. The first layer 344 is interposed between the metallic support 31 and the second layer 345. The first layer 344 is made of, for instance, Cr₂O₃.

The second layer 345 is disposed between the first layer 344 and the frame 32. The first adherence part 34 includes the third layer 346; hence, the second layer 345 is interposed between the first layer 344 and the third layer 346. Besides, the second layer 345 is interposed in part between the metallic support 31 and the frame 32.

An oxide, of which the second layer 345 is made, is preferably different from an oxide, of which the first layer 344 is made. In this setting, when a crack is about to advance in the Z-axis direction from the first layer 344 toward the second layer 345 or vice versa, it is made possible to stop the crack advance at an interface between the first and second layers 344 and 345. For example, the second layer 345 is made of a chromium-manganese oxide.

The third layer 346 is disposed on the frame 32. The third layer 346 is interposed between the second layer 345 and the frame 32. An oxide, of which the third layer 346 is made, is preferably different from the oxide, of which the second layer 345 is made. In this setting, when a crack is about to advance in the Z-axis direction from the second layer 345 toward the third layer 346 or vice versa, it is made possible to stop the crack advance at an interface between the second and third layers 345 and 346. In the present preferred embodiment, the third layer 346 is made of Cr₂O₃.

The oxide, of which the third layer 346 is made, is preferably identical to the oxide, of which the first layer 344 is made. In this setting, the first adherence part 34 is structured to be symmetrical in the thickness direction oriented in parallel to the Z-axis direction; hence, the first adherence part 34 can be enhanced in mechanical reliability.

The first adherence part 34 varies in number of layers in the direction oriented from the internal space 30 toward the outer peripheral edge of the fluid container 3. The first adherence part 34 decreases in number of layers in the direction oriented from the internal space 30 toward the outer peripheral edge of the fluid container 3. Besides, the first adherence part 34 increases in number of layers, after decreasing in number of layers, in the direction oriented from the internal space 30 toward the outer peripheral edge of the fluid container 3.

When described in detail, the number of layers in the first adherence part 34 is three in a first region R1. On the other hand, the number of layers in the first adherence part 34 is one in a second region R2 disposed closer to the outer peripheral edge of the fluid container 3 than the first region R1. Yet on the other hand, the number of layers in the first adherence part 34 is three in a third region R3 disposed closer to the outer peripheral edge of the fluid container 3 than the second region R2. Thus, the first adherence part 34 increases in number of layers, after deceasing in number of layers, in the direction oriented from the internal space 30 toward the outer peripheral edge of the fluid container 3.
(g) In the preferred embodiment described above, the first adherence part 34 includes the first and second taper portions 341 and 342 but may not include the second taper portion 342. In other words, the first interface 4 may not include the third slant portion 42. On the other hand, the second interface 5 may not include the fourth slant portion 52.
(h) In the preferred embodiment described above, the electrochemical cell is exemplified by the electrolytic cell but is not limited thereto. The electrochemical cell is a generic term for referring to an element for changing electric energy into chemical energy, in which a pair of electrodes is disposed to generate an electromotive force from entire oxidoreduction reactions, and an element for changing chemical energy into electric energy. Therefore, a fuel cell, in which oxide ions or protons act as carriers, is considered as the electrochemical cell.
(i) The preferred embodiment described above has been explained as the embodiment that the fluid container according to the present invention is applied to the electrochemical cell; however, the fluid container is usable for a variety of applications. The fluid container is applicable to, for instance, a reactor for methanation to synthesize methane from hydrogen and carbon dioxide.

### REFERENCE SIGNS LIST

2: Cell body
3: Fluid container
30: Internal space
31: Metallic support
32: Frame
34: First adherence part
341: First taper portion
342: Second taper portion
343: Unfilled portion
36: Metallic joint portion
4: First interface
41: First slant portion
42: Third slant portion
5: Second interface
51: Second slant portion
52: Fourth slant portion
100: Electrolytic cell

1. A fluid container including an internal space through which a fluid flows, the fluid container comprising:
a first metallic member containing chromium;
a second metallic member containing chromium;
an adherence part made of an oxide containing chromium as a primary component, the adherence part adhering the first and second metallic members to each other;
a first interface provided as an interface between the first metallic member and the adherence part; and
a second interface provided as an interface between the second metallic member and the adherence part, wherein
the first interface includes a first slant portion slating with respect to an in-plane direction of the first metallic member.

2. The fluid container according to claim 1, wherein
the adherence part annularly extends to enclose the internal space, and
the first slant portion extends along the adherence part.

3. The fluid container according to claim 1, wherein the first slant portion slants in a direction oriented from the internal space toward an outer peripheral edge of the fluid container.

4. The fluid container according to claim 1, wherein the second interface includes a second slant portion slanting with respect to an in-plane direction of the second metallic member.

5. The fluid container according to claim 4, wherein the first and second slant portions overlap with each other as seen in a thickness direction, the first and second slant portions slant to approach to each other in a direction oriented from the internal space toward an outer peripheral edge of the fluid container.

6. The fluid container according to claim 5, wherein
the first interface includes a third slant portion slanting with respect to the in-plane direction of the first metallic member,
the second interface includes a fourth slant portion slanting with respect to the in-plane direction of the second metallic member,
the third slant portion is disposed closer to the outer peripheral edge than the first slant portion,
the fourth slant portion is disposed closer to the outer peripheral edge than the second slant portion, and
the third and fourth slant portions overlap with each other as seen in the thickness direction, the third and fourth slant portions slant to separate from each other in the direction oriented from the internal space toward the outer peripheral edge.

7. The fluid container according to claim 6, wherein
the adherence part includes a first taper portion and a second taper portion, the first taper portion defined by the first and second slant portions, the second taper portion defined by the third and fourth slant portions, and
the first taper portion is greater in taper ratio than the second taper portion.

8. The fluid container according to claim 6, further comprising:
a metallic joint portion integrated with the first and second metallic members, the metallic joint portion made of a metallic material, wherein
the adherence part includes a first taper portion and a second taper portion, the first taper portion defined by the first and second slant portions, the second taper portion defined by the third and fourth slant portions, and
the metallic joint portion is disposed between the first taper portion and the second taper portion.

9. The fluid container according to claim 1, wherein the adherence part includes an unfilled portion in an interior thereof, the unfilled portion extending in the in-plane direction of the first metallic member.

10. The fluid container according to claim 1, wherein
the adherence part includes a plurality of layers, and
the number of layers in the adherence part varies in a direction oriented from the internal space toward an outer peripheral edge of the fluid container.

11. The fluid container according to claim 9, wherein the number of layers in the adherence part decreases in the direction oriented from the internal space toward the outer peripheral edge of the fluid container.

12. The fluid container according to claim 1, wherein the adherence part is a seal for sealing the internal space.

13. An electrochemical cell comprising:
the fluid container recited in claim 1; and
a cell body disposed on the fluid container.

14. The electrochemical cell according to claim 13, wherein
the first metallic member includes a plurality of communicating holes continuing to the internal space, and
the cell body is disposed on the first metallic member to cover the plurality of communicating holes.

15. The electrochemical cell according to claim 13, wherein
the second metallic member includes a plurality of communicating holes continuing to the internal space, and
the cell body is disposed on the second metallic member to cover the plurality of communicating holes.
